(19) United States
(12) Patent Application Publication
(10) Pub. No.: US 2010/0126114 A1
(43) Pub. Date: May 27, 2010

(54) APPARATUS FOR CLADDING AN INSULATION MEMBER, A COMPOSITE CLADDED INSULATION MEMBER, AND METHODS OF FORMING AND INSTALLING SAME

(75) Inventor: Chris Sadler, Barrie (CA)

Correspondence Address: LANG MICHENER, BROOKFIELD PLACE, P.O. BOX 747, SUITE 2500, 181 BAY STREET, TORONTO, ON, M5J 2T7, CA

(73) Assignee: NUCLAD WALL SYSTEMS INC., Barrie, ON (CA)

(21) Appl. No.: 12/595,944

(22) PCT Filed: Apr. 17, 2008
(86) PCT No.: PCT/CA2008/000712

§ 371 Date: Oct. 14, 2009

Related U.S. Application Data
(60) Provisional application No. 60/912,402, filed on Apr. 17, 2007.

(51) Int. Cl. E04C 2/284; E04C 2/40; B23P 11/00; B05C 13/00; B05C 5/00

(52) U.S. Cl. 52/791.1; 52/796.1; 29/428; 29/458; 118/500; 118/324

(57) ABSTRACT

A cladding apparatus includes a receiving member securing an insulation member, and a forming member having a delivery portion and a base. A cladding surface of the base is spaced from a coatable surface of the insulation member to define a cavity. A conduit of the delivery portion delivers a coating material, through a coating aperture in the base, into the cavity. The cladding surface forms a composite cladded insulation piece, including a coating layer bonded to the coatable surface. An inner coating surface of the coating layer has projections securely encasing the coated surface of the insulation member. A mounting surface of the insulation member is mounted on a building substrate. A wall finish is applied to an outer surface of the coating layer. Corresponding methods of forming and installing the pieces are also provided.

### FIELD OF THE INVENTION

The present invention relates to the field of insulation and cladding for use in building construction, and more particularly, to an apparatus for cladding an insulation member, to a composite cladded insulation member, and to methods of forming and installing same.

### BACKGROUND OF THE INVENTION

The field of building construction is one in which various previously known methods may have been used to apply different types of cladding and wall finishes to the exterior of buildings. A few exemplary wall finishes in the prior art include paint, stone veneer, brick and stucco. These and other wall finishes may have been conventionally applied over a substrate material or wall sheathing (e.g., plywood, insulating fiber board, dry-wall, and concrete).

Previously, in an Exterior Insulation and Finish System (EIFS), it has been known to apply a mesh and multiple base coats, manually by trowel, over an insulating foam board (mounted on a substrate attached to building supports), before applying an acrylic top coat (or synthetic stucco) thereover. In this manner, EIFS is a system which may have previously been used to create exterior insulated walls with a cladded and finished surface. Traditionally, EIFS may have included synthetic wall cladding, with foam plastic insulation or EPS boards adhered to a substrate material by adhesive or mechanical anchors. As aforesaid, EIFS is a system that involves a labor-intensive layered application of synthetic coatings (e.g., fiber mesh material, cementitious material, and stucco).

As aforesaid, the cementitious material, stucco, insulated foam (e.g., expanded polystyrene or EPS) board, and/or fiber mesh materials of the EIFS may have been conventionally applied, by hand, in the field at the construction site. It may be worthwhile to highlight the fact that the installation or application of a conventional EIFS may have required independent professional contractors to apply, by hand, the synthetic coatings and wall finish. This field-application process may have required a considerable amount of cost, time and/or effort. Moreover, any final product which may have been achieved by such prior methods may have tended to be somewhat weak, and subject to irregular and/or inconsistent thicknesses, possibly with substantially little control over the application process in what may inherently be an uncontrolled outdoor environment.

FIG. 1 illustrates some of the prior art materials which may have been previously assembled (in the field) to effect a field-installed system. The traditional wall assembly 20 shown in FIG. 1, whether manufactured by EIFS or by some other system, may have included a wall support member 22 (e.g., a stud, possibly one constructed of metal) and a substrate 24 (usually plywood) installed thereagainst to form a backing. A water-resistant barrier (not shown) may have then been applied to the substrate 24, followed by an adhesive 26. Thereafter, a conventional insulation board 28—e.g., expanded polystyrene (EPS)—would have been attached to the substrate 24. Next, a plurality of base coats of a coating material 32 (e.g., a cementitious material), with a reinforcing mesh 30 embedded therein, may typically have been required to be applied manually. Various venting assemblies (not shown) may have been applied and/or utilized, before application of the final stucco finish coat 34. Each step was previously required to be performed in the field, and each step may typically have heretofore required good weather and/or skilled labor, so as to properly install and/or perform the steps of the prior art systems.

Disadvantages associated with the prior art may have included that the assembly took place under uncontrolled environmental conditions, subject to comparatively little or no consistent quality control, with a high dependence on the weather, and on skilled labor, inter alfa, to provide a rudimentary method of fastening the prior art systems to buildings.

In addition, the insulation board 28 that was previously used was inherently incompatible with the mesh material 30 that was thereafter applied and/or bonded thereto. That is—and quite apart from the mesh 30 and the insulation board 28 used in prior art systems not having been particularly adapted for use with one another—the sizing of the one to the other was typically such that, in the course of installing the systems, sequential edges of the mesh 30 would not consistently line up with portions of the insulation board 28. In the result, the edge of the mesh 30 might overlie either an edge, or the middle portion, of the insulation board 28. This mismatching of the mesh 30 and insulation board 28 may have previously tended to result in a relatively high incidence of wasted or scrap materials, and/or in an inefficient use of skilled labor. In fact, it may have been only through the workman's attentive and dedicated application of skill, while also burdened with the difficult and contemporaneous task of manually applying a consistent thickness of cementitious material 32 to the insulation board 28 in-the-field, that the mesh 30 and the insulation board 28 might have been particularly adapted, one pair at a time, for use together in the prior art systems.

Moreover, the typical prior art wall assembly 20—whether assembled, by hand, in keeping with the EIFS or another system—may have been highly susceptible to moisture intrusion. Accordingly, a high degree of skill and/or precision may heretofore have been required in performing an installation, according to conventional EIFS methods, to ensure a snug fit between connecting insulation boards 28. Imprecise field installation of the insulation boards 28, and/or in the application of the numerous and labor-intensive layered coatings, may heretofore have resulted, in some cases, in the intrusion of rain water, and/or the in build up of moisture, behind such prior art wall assemblies 20, thus producing (as a direct or indirect cause) structural damage and/or damage to associated wall finishes 34.

The serious EIFS moisture problems may have been previously identified and documented. According to a study commissioned by the NAHB (National Association of Home Builders), homes surveyed “ages two to six are experiencing structural damage due to excessive moisture buildup within walls.

The cause of the moisture accumulation is rain water intrusion from a combination of factors including: improper sealing at joints and around windows, doors, and other penetrations; improperly sloped horizontal EIFS surfaces; inadequate flashing at roof lines, dormers, decks, etc.; and window frames that leak into wall cavities.”

It is an object of one preferred embodiment according to the invention to provide a cladding apparatus to form composite cladded insulation pieces.

It is an object of one preferred embodiment according to the invention to provide a cladding apparatus for use with a coating material and an insulation member.

It is an object of one preferred embodiment according to the invention to provide a composite cladded insulation piece comprised of a coating layer in substantially bonded relation with an insulation member.

It is an object of one preferred embodiment according to the invention to provide a composite cladded insulation piece.

It is an object of one preferred embodiment according to the invention to provide a method of forming a composite cladded insulation piece.

It is an object of one preferred embodiment according to the invention to provide a method of installing composite cladded insulation pieces.

It is an object of one preferred embodiment according to the invention to provide a cladding apparatus, a composite cladded insulation piece, and/or method of forming or installing same that may avoid, and/or overcome, previous problems associated with conventional (EIFS or other) wall assembly installations.

It is an object of one preferred embodiment according to the invention to provide a cladding apparatus to form composite cladded insulation pieces for use in interior or exterior wall cladding applications.

It is an object of one preferred embodiment according to the invention to minimize or reduce costs and/or time associated with the use of insulation and/or (other) cladding in the field of building construction.

It is an object of the present invention to obviate or mitigate one or more of the aforementioned mentioned disadvantages associated with the prior art, and/or to achieve one or more of the aforementioned objects of the invention.

### SUMMARY OF THE INVENTION

In accordance with the present invention, there is disclosed a cladding apparatus for use with a coating material and with an insulation member having at least one coatable surface. According to the invention, the apparatus includes a receiving member and a forming member. The receiving member is operative to securely retain the insulation member. The forming member includes a base portion and a coat delivery portion. The base portion defines a coating aperture therethrough. The base portion has a cladding surface operatively positioned in spaced relation from the coatable surface to define a coating cavity therebetween. The coat delivery portion includes a delivery conduit, in fluid communication with the coating aperture, and operatively delivering the coating material into the coating cavity substantially adjacent to the coatable surface. The coat delivery portion and the cladding surface together operatively form a coating layer of the coating material, in substantially bonded relation, on the coatable surface. In this manner, the cladding apparatus operatively forms a composite cladded insulation piece comprised of the coating layer in substantially bonded relation with the insulation member.

According to an aspect of one preferred embodiment of the invention, the receiving member includes a substantially elongate conveyor, preferably having a conveyor entry end portion and a conveyer exit end portion. The conveyor may preferably, but need not necessarily, be operative to move the insulation member from the conveyor entry end portion, in a manufacturing direction, toward the conveyor exit end portion.

According to an aspect of one preferred embodiment of the invention, the base portion is positioned in a substantially vertical direction above the conveyor. The cladding surface may preferably, but need not necessarily, be operatively positioned in a substantially vertical direction above the insulation member.

According to an aspect of one preferred embodiment of the invention, the base portion has a base entry end portion and a base exit end portion spaced, in the manufacturing direction, from the base entry end portion. The coating aperture may preferably, but need not necessarily, be located between the base entry end portion and the cladding surface. The cladding surface may preferably, but need not necessarily, be located between the coating aperture and the base exit end portion.

According to an aspect of one preferred embodiment of the invention, the coating layer is operatively extruded in the manufacturing direction from the base exit end portion, preferably as the conveyor operatively moves the insulation member toward the conveyor exit end portion.

According to an aspect of one preferred embodiment of the invention, the cladding surface has two opposing transverse surface edge portions, each preferably shaped to form a recessed portion in a coating edge portion of the coating layer.

According to an aspect of one preferred embodiment of the invention, the receiving member includes one or more elongate containment members, preferably operative to retain the insulation member.

According to an aspect of one preferred embodiment of the invention, the receiving member includes two opposing elongate containment members, preferably operative to together retain the insulation member therebetween. The containment members may preferably, but need not necessarily, extend along the conveyor between the conveyor entry end portion and the conveyor exit end portion.

According to an aspect of one preferred embodiment of the invention, the containment members extend from substantially adjacent to the conveyor entry end portion.

According to an aspect of one preferred embodiment of the invention, the receiving member also includes at least one advancing member, preferably operative to securely engage the insulation member, and preferably to assist in moving the insulation member in the manufacturing direction toward the conveyor exit end portion.

According to an aspect of one preferred embodiment of the invention, the advancing member includes one or more advancing projection members, preferably operative to matingly and securely engage the insulation member.

According to an aspect of one preferred embodiment of the invention, the apparatus is also for use with a reinforcing member. The forming member may preferably, but need not necessarily, be operative to embed the reinforcing member within the coating layer.

According to an aspect of one preferred embodiment of the invention, the apparatus is also for use with a reinforcing member, and it preferably includes a reinforcing feeder. The cladding surface may preferably, but need not necessarily, be located substantially in the manufacturing direction from the reinforcing feeder. The reinforcing feeder may preferably, but need not necessarily, operatively convey the reinforcing member between the coatable surface and the cladding surface substantially in the manufacturing direction. The forming member may preferably, but need not necessarily, be operative to embed the reinforcing member within the coating layer.

According to an aspect of one preferred embodiment of the invention, the reinforcing feeder includes a spindle, preferably operative to rollably dispense the reinforcing member to an insertion position, above the conveyor, from which the reinforcing member is preferably conveyed between the coatable surface and the cladding surface.

According to an aspect of one preferred embodiment of the invention, the reinforcing feeder includes one or more sprocket wheels, preferably operative to convey the reinforcing member, from an insertion position above the conveyor, between the coatable surface and the cladding surface.

According to an aspect of one preferred embodiment of the invention, the reinforcing feeder includes one or more feeder arms, preferably operative to convey the reinforcing member, from an insertion position above the conveyor, between the coatable surface and the cladding surface.

According to an aspect of one preferred embodiment of the invention, the feeder arms are located substantially adjacent to the conveyor entry end portion.

According to an aspect of one preferred embodiment of the invention, the apparatus is for use with a reinforcing fiber mesh material as the reinforcing member.

According to an aspect of one preferred embodiment of the invention, the apparatus also includes support members. The forming member may preferably, but need not necessarily, include suspension arms operative to securely engage the support members. The base portion may preferably, but need not necessarily, be suspended above the receiving member.

According to an aspect of one preferred embodiment of the invention, the base portion is shaped to define at least one pressure relief aperture therethrough.

According to an aspect of one preferred embodiment of the invention, the base portion is shaped to define at least one pressure relief aperture through the cladding surface. The pressure relief aperture may preferably, but need not necessarily, be substantially linear and extend in a substantially transverse direction. The pressure relief aperture may preferably, but need not necessarily, be located between the coating aperture and the base exit end portion.

According to an aspect of one preferred embodiment of the invention, the coat delivery portion includes a hopper, preferably operative to contain and deliver the coating material, in fluid communication, to the delivery conduit.

According to an aspect of one preferred embodiment of the invention, the delivery conduit includes a venturi-shaped portion, preferably substantially adjacent to the coating aperture.

According to an aspect of one preferred embodiment of the invention, the coat delivery portion includes a delivery mechanism, preferably a progressive cavity pump, and preferably operative to deliver the coating material from the delivery conduit into the coating cavity.

According to an aspect of one preferred embodiment of the invention, the apparatus is for use with a cementitious material as the coating material.

According to an aspect of one preferred embodiment of the invention, the apparatus is for use with a panel section as the insulation member.

According to an aspect of one preferred embodiment of the invention, the apparatus is for use with a wall panel as the insulation member.

According to an aspect of one preferred embodiment of the invention, the apparatus is for use with a roofing panel as the insulation member.

In accordance with the present invention, there is also disclosed a composite cladded insulation piece apparatus. The apparatus is for use with a building substrate member and a wall finish material. According to the invention, the apparatus includes an elongate insulation member and a hardened coating layer. The insulation member has at least one inner mounting surface that is operatively mounted on the building substrate member. The insulation member also has at least one outer coated surface that is formed discretely from the aforesaid at least one mounting surface. The hardened coating layer has at least one outer finishing surface, and at least one inner coating surface. The inner coating surface is substantially coterminous with, and completely covers, the coated surface in securely bonded relation. The coating surface is shaped to define two or more transversely spaced coating projection portions. Each of the coating projection portions extends from the inner coating surface in an inward direction or an outward direction to securely engage the coated surface in substantially encasing relation. The outer finishing surface is operatively coated with the wall finish material.

According to an aspect of one preferred embodiment of the invention, the apparatus also includes a reinforcing member embedded within the hardened coating layer.

According to an aspect of one preferred embodiment of the invention, the reinforcing member is constructed from a fiber mesh material.

According to an aspect of one preferred embodiment of the invention, the outer finishing surface is substantially planar.

According to an aspect of one preferred embodiment of the invention, the hardened coating layer has a substantially uniform thickness.

According to an aspect of one preferred embodiment of the invention, the hardened coating layer is formed from a cementitious material.

According to an aspect of one preferred embodiment of the invention, the coating projection portions extend from the inner coating surface in the inward direction. The coated surface may preferably, but need not necessarily, be shaped to define two or more transversely spaced strengthening grooves therein. The coating projecting portions may preferably, but need not necessarily, matingly engage the strengthening grooves.

According to an aspect of one preferred embodiment of the invention, the apparatus also includes a reinforcing member embedded within the hardened coating layer. The coating projection portions may preferably, but need not necessarily, extend from the inner coating surface in the inward direction. The coated surface may preferably, but need not necessarily, be shaped to define two or more transversely spaced strengthening grooves therein. The coating projection portions may preferably extend, beyond the reinforcing member, in mating engagement with the strengthening grooves, preferably so as to strengthen the hardened coating layer.

According to an aspect of one preferred embodiment of the invention, one or more of the coating projection portions and the strengthening grooves operatively receive at least one fastener, preferably to fasten the inner mounting surface to the building substrate member.

According to an aspect of one preferred embodiment of the invention, the fastener is countersunk within the coating projection portions.

According to an aspect of one preferred embodiment of the invention, the coating projection portions matingly engage the strengthening grooves in securely bonded relation.

According to an aspect of one preferred embodiment of the invention, the inner mounting surface is shaped so as to define one or more substantially vertical drainage channels therein.

According to an aspect of one preferred embodiment of the invention, the inner mounting surface is additionally shaped so as to define one or more substantially horizontal drainage channels therein. Preferably, at least one of the horizontal drainage channels intersects at least one of the vertical drainage channels.

According to an aspect of one preferred embodiment of the invention, the insulation member is constructed from expanded polystyrene insulation.

According to an aspect of one preferred embodiment of the invention, the insulation member is a panel section.

According to an aspect of one preferred embodiment of the invention, the panel section is a wall panel.

According to an aspect of one preferred embodiment of the invention, the panel section is a roofing panel.

According to an aspect of one preferred embodiment of the invention, the outer finishing surface has two opposing transverse coating edge portions, with each of the transverse coating edge portions preferably, but not necessarily, being shaped to define a recessed portion.

According to an aspect of one preferred embodiment of the invention, the apparatus is for use with a stucco material as the wall finish material.

In accordance with the present invention, there is also disclosed a method of installing composite cladded insulation pieces. According to the invention, the method includes a mounting step and a finishing step. In the mounting step, at least one inner mounting surface of an elongate insulation member of at least a first one of the pieces is mounted on a building substrate member. In the finishing step, a wall finishing coating of a wall finish material is applied substantially directly onto an outer finishing surface of a hardened coating layer of the first one of the pieces.

According to an aspect of one preferred embodiment of the invention, in the mounting step, a fastener may preferably, but need not necessarily, extend (a) through an outer finishing surface of the hardened coating layer, (b) through a coating projection portion that extends in an inward direction from an inner coating surface of the hardened coating layer, (c) through a strengthening groove formed in a coated surface of the insulation member, (d) through the inner mounting surface of the insulation member, and/or (e) into the building substrate member, preferably so as to fasten the inner mounting surface to the building substrate member.

According to an aspect of one preferred embodiment of the invention, in the mounting step, at least one inner mounting surface of at least a second one of the pieces is mounted on the building substrate member, preferably substantially adjacent to the first one of the pieces. The method may preferably, but need not necessarily, also include a taping step, preferably after the mounting step and before the finishing step, of applying a joining tape to adjacent coating edge portions of the first one and the second one of the pieces. In the finishing step, the wall finishing coating of the wall finish material may preferably, but need not necessarily, be applied substantially directly onto (a) an outer finishing surface of the first one of the pieces, (b) an outer finishing surface of the second one of the pieces, and/or (c) the joining tape applied to the adjacent coating edge portions of the first one and the second one of the pieces.

According to an aspect of one preferred embodiment of the invention, in the taping step, the joining tape is applied to recessed portions of adjacent coating edge portions of the first one and the second one of the pieces.

In accordance with the present invention, there is also disclosed a method of forming a composite cladded insulation piece. According to the invention, the method includes an insulation retaining step, a form positioning step, a coat delivery step, and a coat forming step. In the insulation retaining step, an insulation member is securely retained. In the form positioning step, a cladding surface of a forming member is positioned in spaced relation from a coatable surface of the insulation member to define a coating cavity therebetween. In the coat delivery step, a coating material is delivered through a delivery conduit into the coating cavity substantially adjacent to the coatable surface. In the coat forming step, the cladding surface forms a coating layer of the coating material, in substantially bonded relation, on the coatable surface.

According to an aspect of one preferred embodiment of the invention, in the insulation retaining step, a substantially elongate conveyor may preferably retain the insulation member. In the form positioning step, the conveyor may preferably, but need not necessarily, move the coatable surface in a manufacturing direction into the aforesaid spaced relation from the cladding surface.

According to an aspect of one preferred embodiment of the invention, in the coat forming step, the coating layer may preferably be extruded in the manufacturing direction by the cladding surface, preferably from a base exit end portion of the forming member, and preferably as the conveyor moves the insulation member toward a conveyor exit end portion thereof.

According to an aspect of one preferred embodiment of the invention, in the coat forming step, two opposing transverse surface edge portions of the cladding surface may preferably form recessed portions in the coating layer.

According to an aspect of one preferred embodiment of the invention, in the form positioning step, the cladding surface is positioned in spaced relation above the coatable surface.

According to an aspect of one preferred embodiment of the invention, in the form positioning step, at least one advancing member may preferably securely engage the insulation member, and may preferably assist in moving the insulation member in the manufacturing direction.

According to an aspect of one preferred embodiment of the invention, in the form positioning step, one or more advancing projection members of the advancing member matingly and securely engage the insulation member.

According to an aspect of one preferred embodiment of the invention, the method also includes a reinforcement positioning step, preferably before the coat delivery step, of positioning a reinforcing member to be embedded within the coating layer in the coat forming step.

According to an aspect of one preferred embodiment of the invention, the method also includes a reinforcement positioning step, preferably before the coat delivery step, of conveying a reinforcing member between the coatable surface and the cladding surface, preferably substantially in the manufacturing direction, and preferably to be embedded within the coating layer in the coat forming step.

According to an aspect of one preferred embodiment of the invention, in the reinforcement positioning step, a spindle rollably dispenses the reinforcing member.

According to an aspect of one preferred embodiment of the invention, in the reinforcement positioning step, one or more sprocket wheels convey the reinforcing member between the coatable surface and the cladding surface.

According to an aspect of one preferred embodiment of the invention, in the reinforcement positioning step, one or more feeder arms convey the reinforcing member between the coatable surface and the cladding surface.

According to an aspect of one preferred embodiment of the invention, in the reinforcement positioning step, a reinforcing fiber mesh material is used as the reinforcing member.

According to an aspect of one preferred embodiment of the invention, in the coat delivery step, a cementitious material is delivered as the coating material.

Other advantages, features and characteristics of the present invention, as well as methods of operation and functions of the related elements of the cladding apparatus, the composite cladded insulation member, and the methods of forming and installing same, and the combination of steps, parts and economies of manufacture, will become more apparent upon consideration of the following detailed description and the appended claims with reference to the accompanying drawings, the latter of which are briefly described hereinbelow.

### BRIEF DESCRIPTION OF THE DRAWINGS

The novel features which are believed to be characteristic of the cladding apparatus, the composite cladded insulation member, and the methods of forming and installing same according to the present invention, as to their structure, organization, use, and method of operation, together with further objectives and advantages thereof, will be better understood from the following drawings in which presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is an outer top right perspective view of a prior art cladded insulation board system, shown in section, as heretofore manually applied in the field;

FIG. 2 is a rear top left perspective view of a cladding apparatus according to a preferred embodiment of the present invention, showing a forming member thereof;

FIG. 2A is an enlarged view of encircled area 2A in FIG. 2;

FIG. 2B is an enlarged view of encircled area 2B in FIG. 2;

FIG. 3 is a front top left perspective view of the cladding apparatus of FIG. 2;

FIG. 3A is an enlarged view of encircled area 3A in FIG. 3;

FIG. 3B is an enlarged view of encircled area 3B in FIG. 3;

FIG. 4 is a top front right perspective view of the forming member shown in FIG. 2;

FIG. 5 is a bottom front right perspective view of the forming member of FIG. 2, showing suspension arms thereof;

FIG. 6 is a front top right perspective view of a composite cladded insulation piece according to a preferred embodiment of the present invention, shown in partial section;

FIG. 7 is an enlarged view of encapsulated area 7 in FIG. 6;

FIG. 8 is an outer front left perspective view of the cladded insulation piece of FIG. 6, shown in use and in partial section;

FIG. 8A is an enlarged view of encircled area 8A in FIG. 8;

FIG. 9 is a front bottom left perspective view of the cladded insulation piece of FIG. 6;

FIG. 10A is a front side elevational view of the cladded insulation piece of FIG. 6;

FIG. 10B is a bottom plan view of the cladded insulation piece of FIG. 6;

FIG. 10C is an enlarged view of encircled area 10C in FIG. 10A;

FIG. 11 is an inner plan view of cladded insulation pieces, as installed according to the invention;

FIG. 12 is a side view of a cladded insulation piece, as installed according to the invention; and

FIG. 13 is a front top right perspective view of a composite cladded insulation piece according to an alternate preferred embodiment of the present invention.

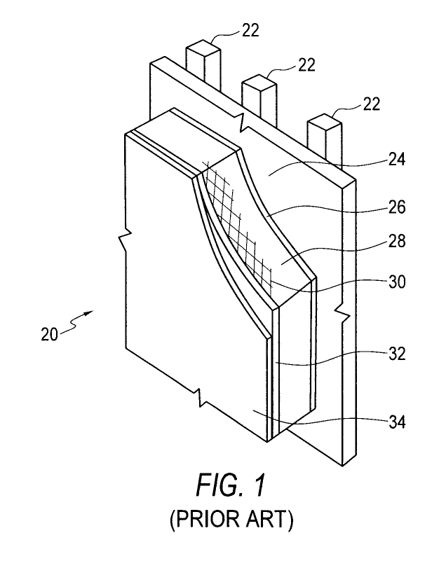

### DETAILED DESCRIPTION OF THE PREFERRED EMBODIMENTS

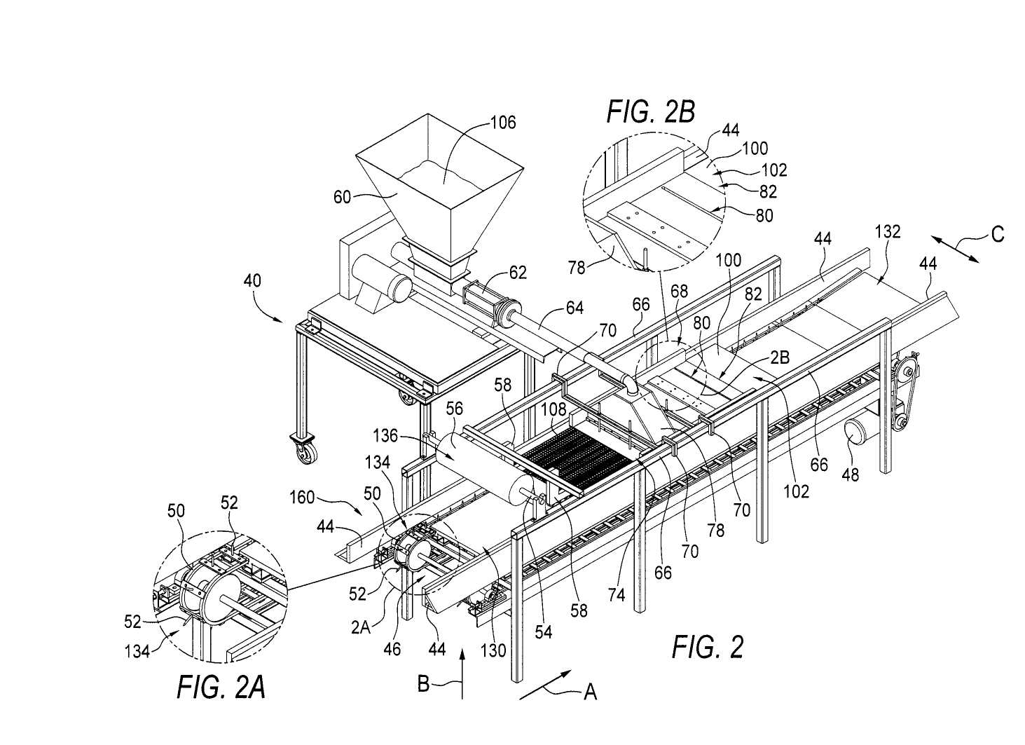

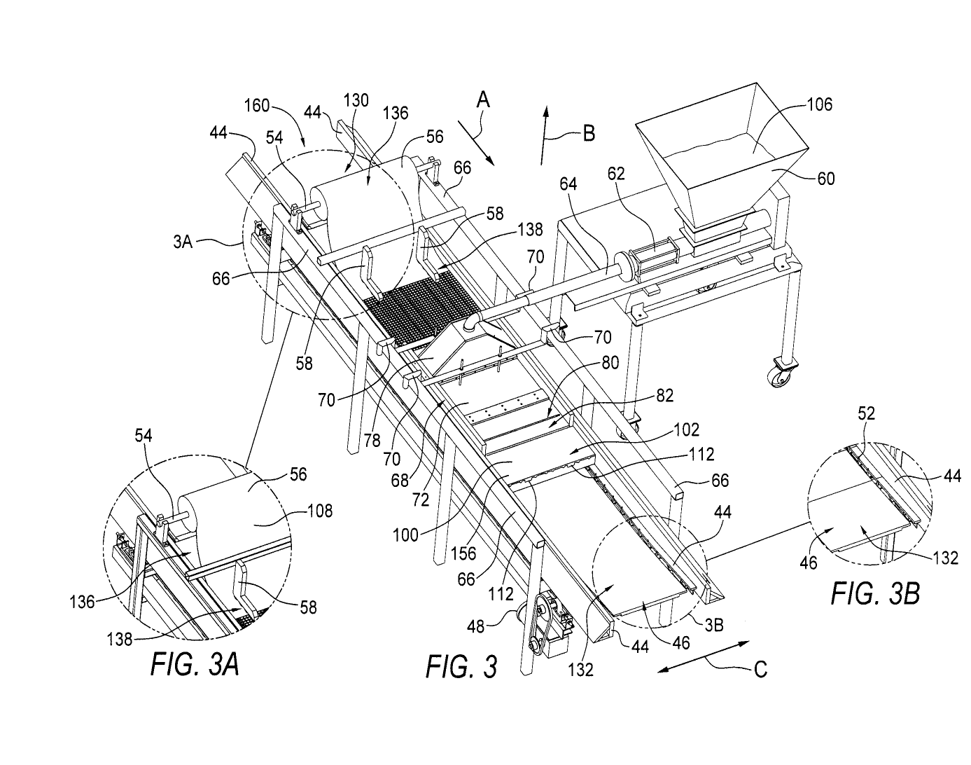

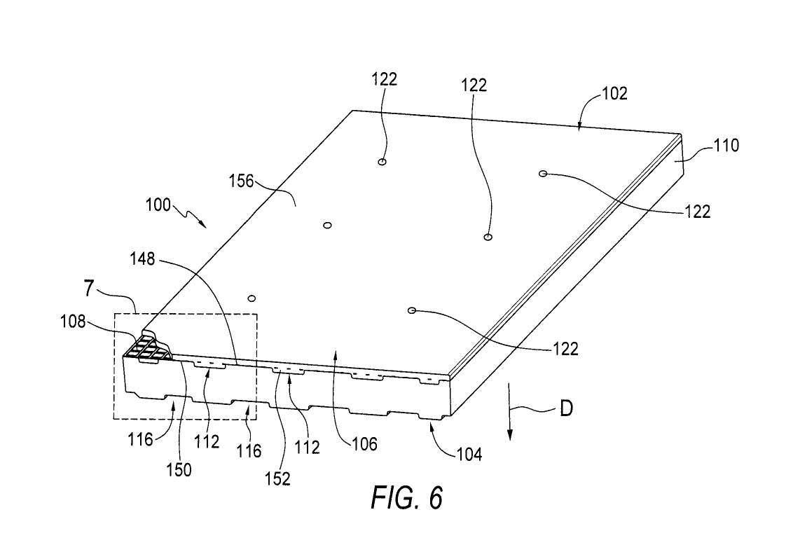

Referring now to FIGS. 2-5 of the drawings, there is shown a cladding apparatus 40 according to a preferred embodiment of the present invention. In FIGS. 2-3B, the cladding apparatus 40 is shown in use with a coating material 106, an insulation member 110, and a reinforcing member 108. The coating material 106 is preferably a cementitious material. The insulation member 110 may be a panel section (e.g., intended for use as a wall panel or roofing panel) or virtually any other insulation form or insulation construction, provided that it has one or more coatable surfaces 148 (as best seen in FIGS. 6-8A, 10A, 10C and 12-13). The reinforcing member 108 is preferably a reinforcing fiber mesh material (as best seen in FIGS. 2-3).

As shown in FIGS. 2-3B, the apparatus 40 includes a receiving member 160, support members 66, a reinforcing feeder 136, and a forming member 68. The receiving member 160 includes two elongate containment members 44, and a substantially elongate conveyor 46 having a conveyor entry end portion 130 and a conveyor exit end portion 132. The conveyor 46 is preferably provided with an electric drive motor 48 (best seen in FIGS. 2 and 3) to urge the conveyor towards the conveyor exit end portion 132. The containment members extend along the conveyor 46, from substantially adjacent to the conveyor entry end portion 130, towards the conveyor exit end portion 132.

As best seen in FIG. 2A, the receiving member 160 also has at least one advancing member 134, preferably including a plurality of advancing projection members 52. The advancing projection members 52 may preferably take the form of spike-like fingers on a driven chain 50. The chain 50 may preferably be driven by the electric drive motor 48 (best seen in FIGS. 2 and 3). Of course, other types of advancing projection members 52, and advancing members 52, are also possible, and fall within the scope of the present invention. Persons having ordinary skill in the art may appreciate that there are other ways of overcoming any resistance which may be associated with passing the insulation members 110 through the forming member 68. For example, conveyor and/or vacuum mechanisms might be used in conjunction with, or instead of, spike-like fingers or other advancing projection members 52.

As best seen in FIGS. 3 and 3A, the reinforcing feeder 136 preferably includes a spindle 54 carrying a mesh roll 56, and at least one sprocket wheel (not shown). The sprocket wheel may preferably be supported upon the support members 66 above the conveyor 46. In an alternate preferred embodiment shown in FIGS. 2 and 3, the reinforcing feeder 136 may include two feeder arms 58 in place of the sprocket wheel. Either or both of the feeder arms 58 and the sprocket wheel (not shown) are preferably located substantially adjacent to the conveyor entry end portion 130.

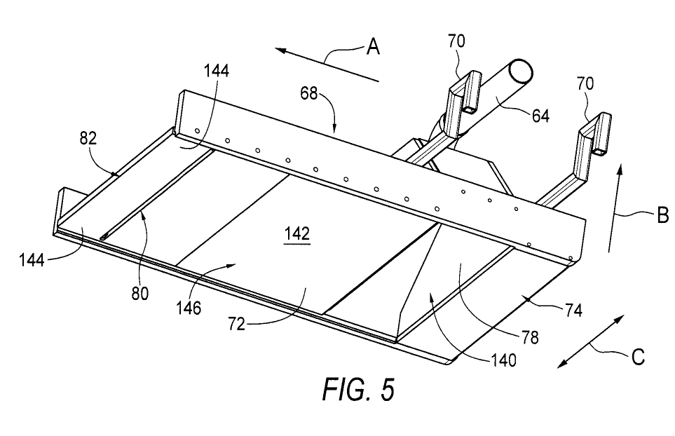

As best seen in FIGS. 2 and 3, the forming member 68 includes a coat delivery portion 60, 64, suspension arms 70, and a base portion 72. The base portion 72 is positioned in a substantially vertical direction (as indicated generally by arrow “B” in FIGS. 2-5) above the conveyor 46. As shown in FIG. 5, the base portion 72 defines a coating aperture 140 therethrough. The base portion 72 has a base entry end portion 74, a cladding surface 142, and a base exit end portion 82. The coating aperture 140 is located between the base entry end portion 74 and the cladding surface 142. The base exit end portion 82 is spaced, in a manufacturing direction (as indicated generally by arrow “A” in FIGS. 2-5), from the base entry end portion 74.

As best seen in FIG. 5, the cladding surface 142 has two opposing transverse surface edge portions 144. As shown in FIGS. 2 and 3, the cladding surface 142 is preferably located, in the manufacturing direction “A” from the reinforcing feeder 136, between the coating aperture 140 and the base exit end portion 82 (shown in FIG. 5). The base portion 72 is also shaped to define at least one pressure relief aperture 80 through the cladding surface 142. The pressure relief aperture 80 is substantially linear and extends in a substantially transverse direction (as indicated generally by arrow “C” in FIGS. 2-5). The pressure relief aperture 80 is located between the coating aperture 140 and the base exit end portion 82.

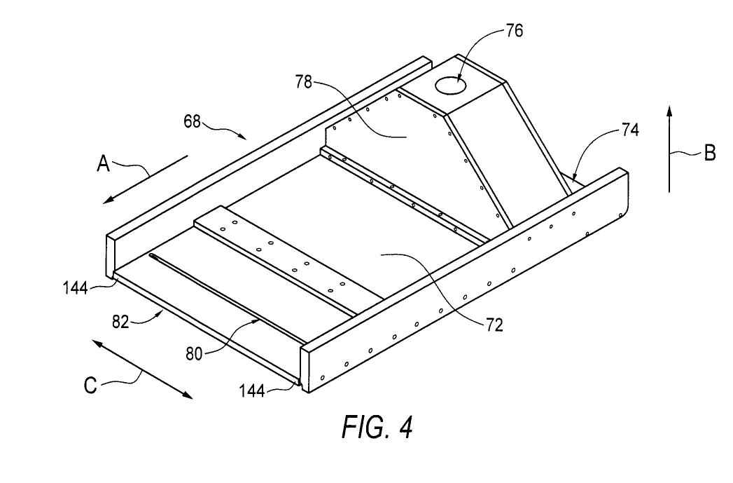

As shown in FIGS. 2 and 3, the coat delivery portion 60, 64 includes a hopper 60, and a delivery conduit 64 in fluid communication with both the hopper 60 and the coating aperture 140 (shown in FIG. 5). Preferably, the coat delivery portion 60, 64 also includes a delivery mechanism—most preferably a progressive cavity pump 62. The delivery conduit 64 includes a venturi entry aperture 76 (shown in FIG. 4) leading into a venturi-shaped portion 78 substantially adjacent to the coating aperture 140. The pressure relief aperture 80 is preferably provided “downstream” of the venturi-shaped portion 78.

In use of the apparatus 40, the opposing elongate containment members 44 of the receiving member 160 together securely retain the insulation member 110. The conveyor 46 operatively moves the insulation member 110 from the conveyor entry end portion 130, in the manufacturing direction “A”, toward the conveyor exit end portion 132. The advancing projection members 52 matingly and securely engage the insulation member 110. The advancing member 134 assists in moving the insulation member 110 in the manufacturing direction “A” toward the conveyor exit end portion 132 (best seen in FIG. 3B).

The suspension arms 70 securely engage the support members 66, such that the base portion 72 is suspended above the receiving member 160. The cladding surface 142 is positioned in spaced relation from the coatable surface 148, in the substantially vertical direction “B” above the insulation member 110, to define a coating cavity 146 therebetween (such as may be appreciated from a consideration of FIGS. 3 and 5).

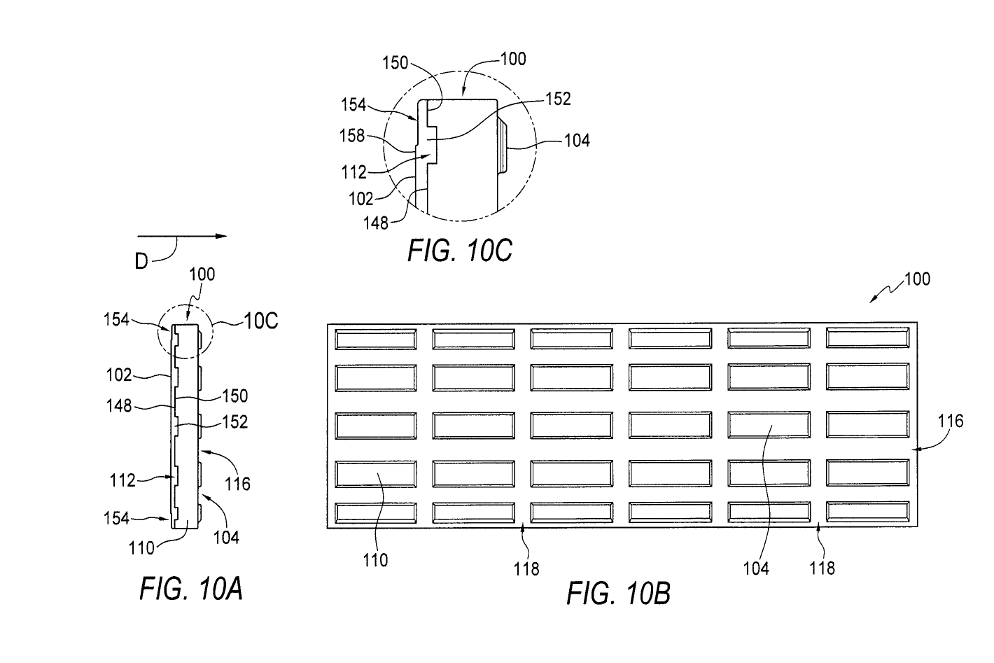

The spindle 54 rollably dispenses the reinforcing member 108 to an insertion position 138 above the conveyor 46. From the insertion position 138, a sprocket wheel (not shown) may preferably rollingly engage the reinforcing member 108 on top of the insulation member 110. In this manner, the sprocket wheel may preferably convey the reinforcing member 108 between the coatable surface 148 and the cladding surface 142 substantially in the manufacturing direction “A”. Similarly, in the alternate preferred embodiment shown in FIGS. 2 and 3, the feeder arms 58 may convey the reinforcing member 108 between the coatable surface 148 and the cladding surface 142. It may be preferable to introduce the reinforcing member 108 (as best seen in FIGS. 3 and 3A) just prior to the coating material 106 being flowed through the forming member 68. In this manner, a composite cladded insulation piece 100 (such as may be ultimately formed by the cladding apparatus 40) may preferably be produced inline in predetermined lengths, such as, for example, in the predetermined length shown in FIG. 10B. It may also be worthwhile to note that, alternately, the reinforcing member 108 might be introduced, through an aperture (not shown) provided in, and located somewhere between the base entry end portion 74 and the base exit end portion 82 of, the forming member 68.

The hopper 60 contains and delivers the coating material 106, in fluid communication, to the delivery conduit 64. The delivery mechanism (e.g., the progressive cavity pump 62) urges the coating material 106 from the delivery conduit 64 into the coating cavity 146. It may be worthwhile to note that, while the FIGS. 2 and 3 depict the use of a progressive cavity pump 62 to deliver the coating material 106, the present invention is not so limited. In fact, it is contemplated that any delivery mechanism, method or means suitable to supply the coating material 106 under pressure to the forming member (alternately herein referred to as a “die assembly”) 68 may be used. Other suitable delivery mechanisms may include other pumps and gravity fed methods (not shown).

In the aforesaid manner, the delivery conduit 64 delivers the coating material 106 into the coating cavity 146 substantially adjacent to the coatable surface 148. Flow of the coating material 106 onto the coatable surface 148 is preferably such that the coating material 106 will flow into strengthening grooves 112, 114 (as described in considerably greater detail elsewhere herein) of the insulation member 110. Preferably, the flow of the coating material 106 into the strengthening grooves 112, 114 may aid in joining the coating material 106 with the insulation member 110. In this regard, the depth and/or surface area of the grooves 112, 114 may preferably assist in strengthening the composite cladded insulation piece 100.

The cladding surface 142, together with the coat delivery portion 60, 64, forms a coating layer 156 of the coating material 106, in substantially bonded relation, on the coatable surface 148. The forming member 68 embeds the reinforcing member 108 within the coating layer 156.

Preferably, the pressure relief aperture 80 may assist in providing a smooth finished outer finishing surface 102 of the coating layer 156 in the composite cladded insulation piece 100—i.e., preferably directly off the cladding apparatus 40. The coating layer 156 is extruded in the manufacturing direction “A” from the base exit end portion 82, as the conveyor 46 moves the insulation member 110 toward the conveyor exit end portion 132. Each of the surface edge portions 144 is shaped to form a recessed portion 154 in a coating edge portion of the coating layer 156 (as best seen in FIGS. 10A and 10C).

In this manner, the cladding apparatus 40 forms the composite cladded insulation piece 100 comprised of the coating layer 156 in substantially bonded relation with the insulation member 110.

Of course, the apparatus 40 may also preferably be used in, and described in the context of, a method of forming the composite cladded insulation piece 100. It may be worthwhile to note that this forming method (as described in detail hereinafter) may also be used independently of the specific cladding apparatus 40 shown in FIGS. 2-5. The forming method preferably includes an insulation retaining step, a form positioning step, a reinforcement positioning step, a coat delivery step, and a coat forming step. In the insulation retaining step, the conveyor 46 retains the insulation member 110.

In the form positioning step, the conveyor 46 moves the coatable surface 148 of the insulation member 110, in the manufacturing direction “A”, into the aforesaid spaced relation relative to the cladding surface 142 of the forming member 68. The cladding surface 142 is preferably positioned above the coatable surface 148. In this manner, the coating cavity 146 is defined between the cladding surface 142 and the coatable surface 148.

In the form positioning step, the advancing projection members 52 of the advancing member 134 matingly and securely engage the insulation member 110. The advancing member 134 preferably assists in moving the insulation member 110 in the manufacturing direction “A”.

The reinforcement positioning step preferably occurs before the coat delivery step. In the reinforcement positioning step, a spindle 54 rollably dispenses the reinforcing member 108 (preferably a reinforcing fiber mesh material), and the reinforcing member 108 is positioned to enable it to be embedded within the coating layer 156 in the coat forming step. Preferably, the sprocket wheel (not shown) conveys the reinforcing member 108, substantially in the manufacturing direction “A”, between the coatable surface 148 and the cladding surface 142. Alternately, in the reinforcement positioning step, the feeder arms 58 (shown in FIGS. 2 and 3) may convey the reinforcing member 108 between the coatable surface 148 and the cladding surface 142.

In the coat delivery step, the coating material 106 is delivered through a delivery conduit 64 into the coating cavity 146 substantially adjacent to the coatable surface 148.

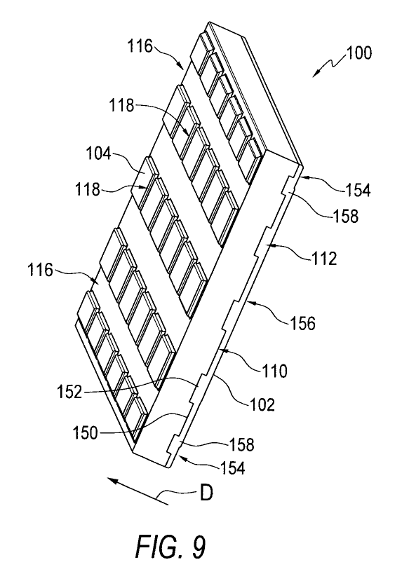

In the coat forming step, the cladding surface 142 forms the coating layer 156 of the coating material 106 (preferably, a cementitious material), in substantially bonded relation, on the coatable surface 148. The forming member 68 extrudes the coating layer 156, in the manufacturing direction “A”, from the cladding surface 142 adjacent to the base exit end portion 82. The coating layer 156 is extruded as the conveyor 46 moves the insulation member 110 toward the conveyor exit end portion 132. As the coating layer 156 is extruded, the opposing transverse surface edge portions 144 of the cladding surface 142 form the recessed portions 154, 154 (best seen in FIGS. 9, 10A and 10C) in the coating layer 156.

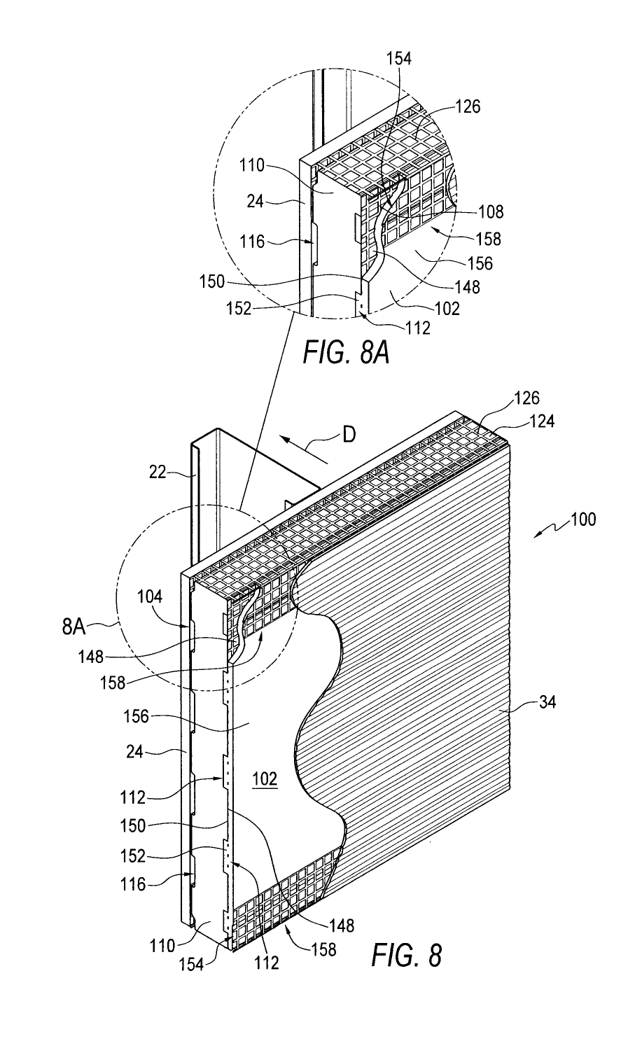

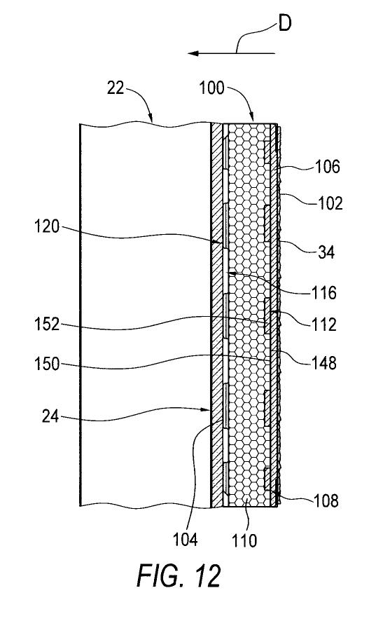

Referring now to FIGS. 6-13 of the drawings, there is best seen the composite cladded insulation piece 100 according to the invention. The piece 100 may be manufactured using the apparatus 40 or by other means. In FIGS. 8 and 12, the piece 100 is shown in use with a building substrate member 24 and a wall finishing coating 34 of a wall finish material. The wall finish material may preferably be a stucco material (e.g., an exterior stucco material).

More particularly, the piece 100 includes the elongate insulation member 110, a hardened coating layer 156 (i.e., preferably the coating layer 156 once hardened), and the reinforcing member 108 embedded within the hardened coating layer 156. Preferably, and as aforesaid, the reinforcing member 108 is constructed from a fiber mesh material, and the hardened coating layer 156 is formed from a cementitious material. As aforesaid, the insulation member 110 is preferably constructed from expanded polystyrene insulation, and may be provided as a panel section (e.g., a wall panel or a roofing panel) or in virtually any other pre-formed insulation shape or insulated article of manufacture.

The insulation member 110 has at least one inner mounting surface 104. As best seen in FIGS. 9 and 10B, the inner mounting surface 104 defines a plurality of substantially vertical drainage channels 118, and a plurality of substantially horizontal drainage channels 116, therein. The horizontal drainage channels 116 intersect the vertical drainage channels 118.

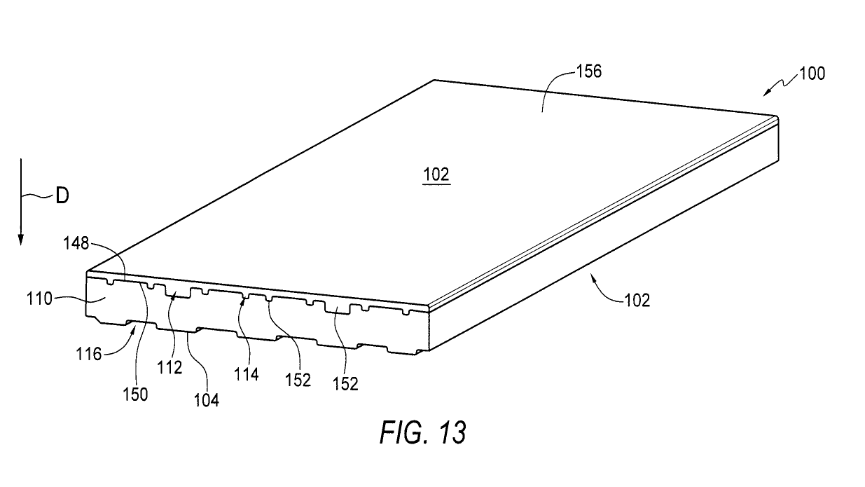

The insulation member 110 also has at least one outer coated surface 148 (alternately, herein referred to as the “coatable surface 148”) that is formed discretely from the mounting surface 104. As best seen in FIGS. 6 and 13, the coated surface 148 is shaped to define a plurality of transversely spaced strengthening grooves 112, 114 therein.

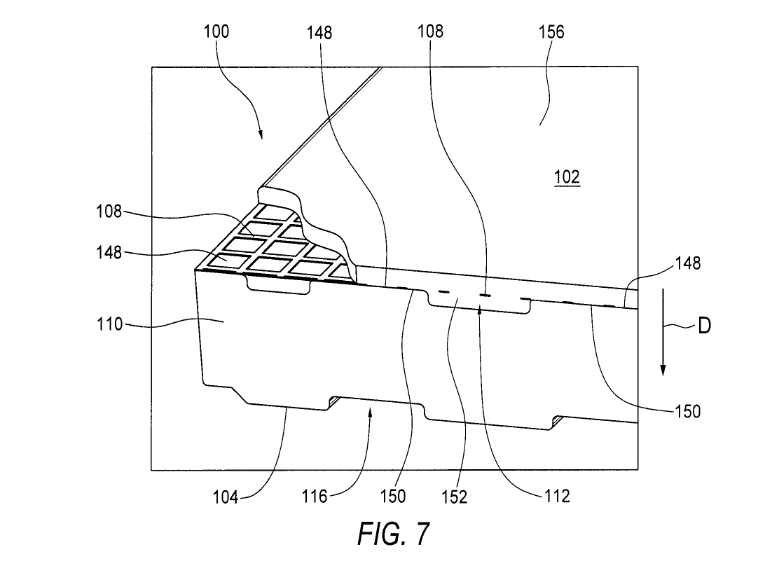

As best seen in FIGS. 6, 9, 10A, 12 and 13, the hardened coating layer 156 has a substantially uniform thickness. The hardened coating layer 156 has at least one outer finishing surface 102, and at least one inner coating surface 150. The inner coating surface 150 is substantially coterminous with, and completely covers, the coated surface 148 in securely bonded relation. The coating surface 150 is shaped to define a plurality of transversely spaced coating projection portions 152. Each of the coating projection portions 152 extends from the inner coating surface 150 in an inward direction (as indicated generally by arrow “D” in FIGS. 6-10A and 12-13). As best seen in FIG. 7, the coating projection portions 152 securely and matingly engage the strengthening grooves 112, 114 of the coated surface 148 in substantially encasing and securely bonded relation. The coating projection portions 152 extend, beyond the reinforcing member 108, so as to strengthen the hardened coating layer 156.

The outer finishing surface 102 is substantially planar. The outer finishing surface 102 has two opposing transverse coating edge portions 158, 158 (as best seen in FIG. 9). As best seen in FIGS. 9, 10A and 10C, each of the transverse coating edge portions 158 is shaped to define a recessed portion 154.

In use of the piece 100, according to the invention, a water-resistant barrier coating 120 may preferably be applied to the building substrate member 24 (as shown in FIG. 12), and the inner mounting surface 104 is operatively mounted on the building substrate member 24.

As shown in FIG. 6, the coating projection portions 152 and the strengthening grooves 112 receive at least one fastener 122 (e.g., a screw) to fasten the inner mounting surface 104 to the building substrate member 24. Preferably, six fasteners 122 may be used per piece 100 (as best seen in FIG. 6). The coating projection portions 152 and the strengthening grooves 112 are preferably such as to enable the fasteners 122 to be countersunk. The strengthening grooves 112 are preferably sized to have a width sufficient to accommodate and/or facilitate the installation of the fasteners 122. When installed, the fasteners 122 may preferably penetrate through the coating layer 156, substantially adjacent to the strengthening grooves 112, and into the supporting substrate 24, preferably so as to provide added strength.

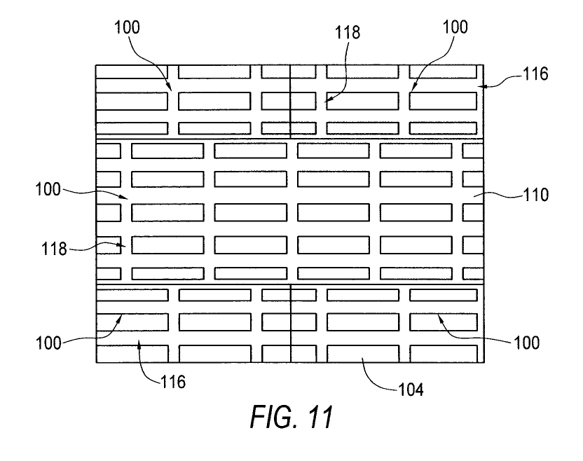

Preferably, when the piece 100 is installed, the drainage channels 116, 118 may help to avoid and/or reduce the amount of moisture that might otherwise accumulate behind the piece 100. As may be best appreciated from a consideration of FIGS. 8 and 8A, a joint compound coating 124 is preferably then applied, together with joint reinforcing fiber mesh 126, between the adjoining edge portions of adjacent pieces 100. As shown in FIG. 11, the adjacent pieces 100, 100 may be staggered such as to offset the drainage channels 116, 118 of each.

Thereafter, the outer finishing surface 102 of the piece 100 is operatively coated with the wall finishing coating 34 of the wall finish material.

Of course, each piece 100 may also preferably be used in, and described in the context of, a method of installing two or more pieces 100, 100. It may be worthwhile to note that this installation method (as described in detail hereinafter) may also be used independently of the specific pieces 100 shown in FIGS. 6-13. The installation method includes a mounting step, a taping step, and a finishing step.

In the mounting step, first and second pieces 100, 100 are mounted on the building substrate member 24 in substantially adjacent relation to one another. As aforesaid, and as shown in FIG. 11, the adjacent pieces 100, 100 may be staggered relative to one another. When the pieces 100 are mounted on the substrate member 24, and as may be best appreciated from a consideration of FIGS. 8 and 8A, the joint compound coating 124 is preferably then applied, together with the joint reinforcing fiber mesh 126, between the adjoining edge portions of adjacent pieces 100, 100.

The inner mounting surface 104 of the insulation member 110 of each of the pieces 100, 100 is mounted on the building substrate member 24. The fastener 122 extends (a) through the outer finishing surface 102, (b) through the coating projection portion, (c) through the strengthening groove 112, (d) through the inner mounting surface 104, and (e) into the building substrate member 24, so as to fasten the inner mounting surface 104 to the building substrate member 24.

Preferably, the taping step occurs after the mounting step and before the finishing step. In the taping step, a joining tape (not shown) is applied to the adjacent coating edge portions 158, 158 of the first and second pieces 100, 100. The joining tape is preferably applied to the recessed portions 154, 154 of the adjacent coating edge portions 158, 158. The joining tape may be applied to vertically and/or horizontally adjacent coating edge portions 158, 158.

In the finishing step, the wall finishing coating 34 of the wall finish material is applied substantially directly onto (a) the outer finishing surface 102 of each of the first and second pieces 100, 100, and (b) the joining tape applied to the adjacent coating edge portions 158, 158.

It should be appreciated that the present invention extends to include extruded panel sections, base panel extrusions, and systems for use with various exterior and interior wall finishes. Disclosed are means of assembling and installing cladding materials that include a novel EPS (expanded polystyrene) panel, or other insulation board, that is shaped to define strengthening grooves on an exterior surface thereof. Various cement compounds and fiber mesh-like materials may be used in other extruding-like processes, through forming dies, that fall within the scope of the invention.

Other modifications and alterations may be used in the design and manufacture of other embodiments according to the present invention without departing from the spirit and scope of the invention, which is limited only by the accompanying claims of this application. For example, in one contemplated alteration, the outer finishing surface 102 of the piece 100 might be marked to locate the position of the drainage channels 116, 118 on the opposite side thereof. As well, whether in alternate embodiments and/or in the preferred embodiment of the invention, it may be advantageous for the containment rails 44 to end substantially adjacent to the base entry end portion 74 of the forming member 68 (after guiding the insulation members 110 thereto), rather than extending therebeyond along the remaining length of the conveyor 46.

1. A cladding apparatus for use with a coating material and with an insulation member having at least one coatable surface, the apparatus comprising:
a) a receiving member operative to securely retain the insulation member; and
b) a forming member including:
i) a base portion defining a coating aperture therethrough, with the base portion having a cladding surface operatively positioned in spaced relation from the coatable surface to define a coating cavity therebetween; and
ii) a coat delivery portion including a delivery conduit, in fluid communication with the coating aperture, and operatively delivering the coating material into the coating cavity substantially adjacent to the coatable surface;
wherein the coat delivery portion and the cladding surface together operatively form a coating layer of the coating material, in substantially bonded relation, on the coatable surface;
whereby the cladding apparatus operatively forms a composite cladded insulation piece comprised of the coating layer in substantially bonded relation with the insulation member.

2. The apparatus according to claim 1, wherein the receiving member comprises a substantially elongate conveyor having a conveyor entry end portion and a conveyer exit end portion, with the conveyor operatively moving the insulation member from the conveyor entry end portion, in a manufacturing direction, toward the conveyor exit end portion.

3. The apparatus according to claim 2, wherein the base portion is positioned in a substantially vertical direction above the conveyor, and the cladding surface is operatively positioned in a substantially vertical direction above the insulation member.

4. The apparatus according to claim 2, wherein the base portion has a base entry end portion, and a base exit end portion spaced in the manufacturing direction from the base entry end portion, and wherein the coating aperture is located between the base entry end portion and the cladding surface, and the cladding surface is located between the coating aperture and the base exit end portion.

5. The apparatus according to claim 4, wherein the coating layer is operatively extruded in the manufacturing direction from the base exit end portion, as the conveyor operatively moves the insulation member toward the conveyor exit end portion.

6. The apparatus according to claim 2, wherein the cladding surface has two opposing transverse surface edge portions, each shaped to form a recessed portion in a coating edge portion of the coating layer.

7. The apparatus according to claim 1, wherein the receiving member comprises one or more elongate containment members operative to retain the insulation member.

8. The apparatus according to claim 2, wherein the receiving member further comprises two opposing elongate containment members operative to together retain the insulation member therebetween, and wherein the containment members extend along the conveyor between the conveyor entry end portion and the conveyor exit end portion.

9. The apparatus according to claim 8, wherein the containment members extend from substantially adjacent to the conveyor entry end portion.

10. The apparatus according to claim 2, wherein the receiving member further comprises at least one advancing member operative to securely engage the insulation member, and to assist in moving the insulation member in the manufacturing direction toward the conveyor exit end portion.

11. The apparatus according to claim 10, wherein the advancing member comprises one or more advancing projection members operative to matingly and securely engage the insulation member.

12. The apparatus according to claim 1, for use with a reinforcing member, wherein the forming member operatively embeds the reinforcing member within the coating layer.

13. The apparatus according to claim 2, for use with a reinforcing member and further comprising a reinforcing feeder, wherein the cladding surface is located substantially in the manufacturing direction from the reinforcing feeder, and wherein the reinforcing feeder operatively conveys the reinforcing member between the coatable surface and the cladding surface substantially in the manufacturing direction, and the forming member operatively embeds the reinforcing member within the coating layer.

14. The apparatus according to claim 13, wherein the reinforcing feeder comprises a spindle operative to rollably dispense the reinforcing member to an insertion position, above the conveyor, from which the reinforcing member is conveyed between the coatable surface and the cladding surface.

15. The apparatus according to claim 13, wherein the reinforcing feeder comprises one or more sprocket wheels operative to convey the reinforcing member, from an insertion position above the conveyor, between the coatable surface and the cladding surface.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. A composite cladded insulation piece apparatus for use with a building substrate member and a wall finish material, the apparatus comprising:
a) an elongate insulation member having at least one inner mounting surface operatively mounted on the building substrate member, and at least one outer coated surface formed discretely from said at least one mounting surface; and
b) a hardened coating layer having at least one outer finishing surface, and at least one inner coating surface that is substantially coterminous with and completely covers the coated surface in securely bonded relation; wherein the coating surface is shaped to define two or more transversely spaced coating projection portions, with each of the coating projection portions extending from the inner coating surface in an inward direction or an outward direction to securely engage the coated surface in substantially encasing relation; and
wherein the outer finishing surface is operatively coated with the wall finish material.

30. The apparatus according to claim 29, further comprising a reinforcing member embedded within the hardened coating layer.

31. The apparatus according to claim 30, wherein the reinforcing member is constructed from a fiber mesh material.

32. (canceled)

33. (canceled)

34. (canceled)

35. (canceled)

36. The apparatus according to claim 29, further comprising a reinforcing member embedded within the hardened coating layer; wherein the coating projection portions extend from the inner coating surface in the inward direction; wherein the coated surface is shaped to define two or more transversely spaced strengthening grooves therein; wherein the coating projection portions extend, beyond the reinforcing member, in mating engagement with the strengthening grooves, so as to strengthen the hardened coating layer.

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. A method of installing composite cladded insulation pieces, the method comprising the steps of:
a mounting step of mounting at least one inner mounting surface of an elongate insulation member of at least a first one of the pieces on a building substrate member; and
a finishing step of applying a wall finishing coating of a wall finish material substantially directly onto an outer finishing surface of a hardened coating layer of the first one of the pieces.

49. A method according to claim 48, wherein in the mounting step, a fastener extends through an outer finishing surface of the hardened coating layer, through a coating projection portion that extends in an inward direction from an inner coating surface of the hardened coating layer, through a strengthening groove formed in a coated surface of the insulation member, through the inner mounting surface of the insulation member, and into the building substrate member, so as to fasten the inner mounting surface to the building substrate member.

50. A method according to claim 48, wherein in the mounting step, at least one inner mounting surface of at least a second one of the pieces is mounted on the building substrate member substantially adjacent to the first one of the pieces; further comprising a taping step, after the mounting step and before the finishing step, of applying a joining tape to adjacent coating edge portions of the first one and the second one of the pieces; and wherein in the finishing step, the wall finishing coating of the wall finish material is applied substantially directly onto an outer finishing surface of the first one of the pieces, onto an outer finishing surface of the second one of the pieces, and onto the joining tape applied to the adjacent coating edge portions of the first one and the second one of the pieces.

51. A method according to claim 50, wherein in the taping step, the joining tape is applied to recessed portions of adjacent coating edge portions of the first one and the second one of the pieces.

52. A method of forming a composite cladded insulation piece, said method comprising the steps of:
a) an insulation retaining step of securely retaining an insulation member;
b) a form positioning step of positioning a cladding surface of a forming member in spaced relation from a coatable surface of the insulation member to define a coating cavity therebetween;
c) a coat delivery step of delivering a coating material through a delivery conduit into the coating cavity substantially adjacent to the coatable surface; and
d) a coat forming step of forming, with the cladding surface, a coating layer of the coating material, in substantially bonded relation, on the coatable surface.

53. The method according to claim 52, wherein in the insulation retaining step, a substantially elongate conveyor retains the insulation member; and wherein in the form positioning step, the conveyor moves the coatable surface in a manufacturing direction into said spaced relation from the cladding surface.

54. The method according to claim 53, wherein in the coat forming step, the coating layer is extruded in the manufacturing direction by the cladding surface from a base exit end portion of the forming member, as the conveyor moves the insulation member toward a conveyor exit end portion thereof.

55. (canceled)

56. (canceled)

57. (canceled)

58. (canceled)

59. (canceled)

60. (canceled)

61. (canceled)

62. (canceled)

63. (canceled)

64. (canceled)

65. (canceled)
